(19) United States
(12) Patent Application Publication
(10) Pub. No.: US 2009/0271606 A1
(43) Pub. Date: Oct. 29, 2009

(54) INFORMATION PROCESSING DEVICE AND INFORMATION PROCESSING SYSTEM

(75) Inventor: Hiroshi SUGANO, Tachikawa-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/388,799

(22) Filed: Feb. 19, 2009

(30) Foreign Application Priority Data
Apr. 28, 2008 (JP) 2008-117783

(51) Int. Cl. G06F 9/00; H04L 9/00

(52) U.S. Cl. 713/2; 726/1

(57) ABSTRACT

According to one embodiment, an information processing device includes an acquisition module configured to get information for executing an authentication process and information on power-on security policy, from a server connected to a network during power-on, a storage module configured to store the information on power-on security policy in a storage device, an authentication module configured to execute the authentication process by using the information for executing the authentication process, a boot module for executing a process of booting an operating system, when the authentication process has succeeded, and a power-on security policy execution module configured to execute a process which is based on a power-on security policy stored in the storage device, when the information for executing the authentication process and the information on power-on security policy cannot be got.

### CROSS-REFERENCE TO RELATED APPLICATIONS

This application is based upon and claims the benefit of priority from Japanese Patent Application No. 2008-117783, filed Apr. 28, 2008, the entire contents of which are incorporated herein by reference.

### BACKGROUND

1. Field

One embodiment of the present invention relates to an information processing device and an information processing system which are capable of automatically changing security policy for powering on in accordance with a place of use.

2. Description of the Related Art

Recently, there have been problems of information leaks from computers due to computer theft. Needless to say, companies take measures for preventing computer theft, and further, for preventing information leaks from stolen computers.

There is a disclosure of a network API of a BIOS, which is used under a situation where a failure occurred before booting operating system of a computer or the OS fails, for communicating with the computer via a network (refer to Jpn. Pat. Appln KOKAI publication No. 2007-172634).

In order to prevent information leaks from stolen computers, authentication performed during operating system boot may be introduced (what is called BIOS authentication). When a computer is used in an office, however, a user may feel troublesome to execute BIOS authentication every time he/she boots the computer.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram for showing a configuration of an information processing system according to one embodiment of the present invention;

FIG. 2 is an exemplary block diagram for showing a system configuration of an information processing device according to one embodiment of the present invention;

FIG. 3 is an exemplary block diagram for showing a configuration of an information processing system according to one embodiment of the present invention; and

FIG. 4 is an exemplary flowchart for showing procedures of power-on process of an information processing device according to the present invention.

### DETAILED DESCRIPTION

Various embodiments according to the invention will be described hereinafter with reference to the accompanying drawings. In general, according to one embodiment of the invention, an information processing device comprises an acquisition module configured to get information for executing an authentication process and information on power-on security policy, from a server connected to a network during power-on, a storage module configured to store the information on power-on security policy in a storage device, an authentication module configured to execute the authentication process by using the information for executing the authentication process, a boot module configured to execute a process of booting an operating system, when the authentication process has succeeded, and a power-on security policy execution module configured to execute a process which is based on a power-on security policy stored in the storage device, when the information for executing the authentication process and the information on power-on security policy cannot be got.

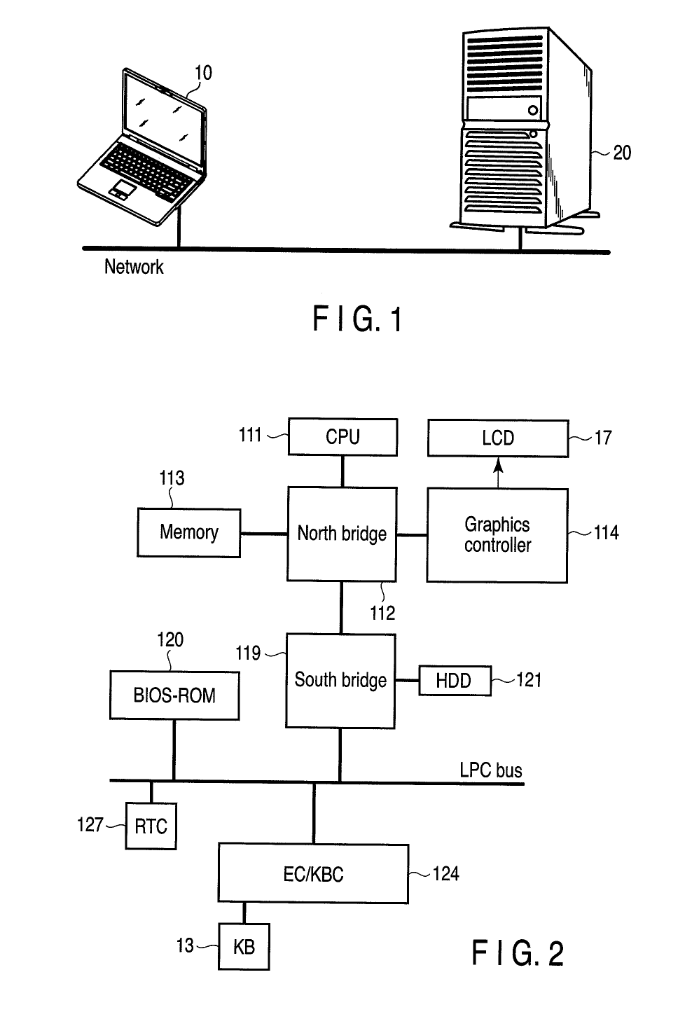

FIG. 1 is a block diagram for showing a configuration of an information processing system according to one embodiment of the present invention.

The information processing system comprises a computer 10 which serves as an information processing device, and a server 20. The computer and the server are connected to a network so as to communicate with each other. This information processing device is realized as a battery-powered, notebook computer 10.

FIG. 2 is a block diagram for showing an example of a system configuration of the computer 10. A configuration of the server is substantially similar to the configuration of the computer 10.

The computer 10, as shown in FIG. 1, incorporates a central processing unit (CPU) 111, a north bridge 112, a main memory 113, a graphics controller 114, a south bridge 119, a BIOS-ROM 120, a hard disk drive (HDD) 121, an embedded controller/keyboard controller IC (EC/KBC) 124, and a real-time crock (RTC) 127, etc.

The CPU 111 is a processor which is provided for controlling operation of the computer 10. The CPU 111 executes an operating system having multitask function and various application programs, which are loaded from the hard disk drive (HDD) 121 into the main memory 113. The OS has a window system for displaying plurality of windows on a display screen.

The CPU 111 also executes a system BIOS (Basic Input Output System) stored in the BIOS-ROM. The system BIOS is a program for hardware control.

The north bridge 112 incorporates a memory controller for access controlling the main memory 113. Also, the north bridge 112 has a function of executing communications with the graphics controller 114 via a PCI EXPRESS bus.

The graphics controller 114 is a display controller for controlling an LCD 17 used as a display monitor of the computer 10. This graphics controller 14 includes a video memory (VRAM), and generates video signals for forming display images to be displayed on the LCD 17, out of display data drawn in the video memory by the OS/application programs.

The south bridge 119 controls each of the devices on a Low Pin Count (LPC) bus. Also, the south bridge 119 incorporates an Integrated Drive Electronics (IDE) controller for controlling the HDD 121. Furthermore, the south bridge 119 has a function for access controlling the BIOS-ROM 120.

The real-time clock (RTC) 127 is a time module (timer) which times time and date. Also, the real-time clock (RTC) 127 has a function of generating an alarm signal, when a period specified by the CPU 111 has elapsed or when a present time and date reaches a time and date specified by the CPU 111.

This computer 10 executes communications with the server 20 during system boot, and gets an authentication file from the server. The computer 10 then executes, when authentication process using the authentication file has succeeded, a process of booting the operating system. In a case where the authentication file cannot be got, the computer 10 executes a boot process in accordance with a power-on security policy included in an authentication file got on the previous boot.

The term “security policy” here is a basic policy that relates to information security. Although in some cases, security policy may mean human restrictions, the “security policy” here means a policy that expresses operational restrictions on the system and the like such as password request and functional restrictions. Particularly, “power-on security policy” means a security policy that is referred to during system boot (power-on).

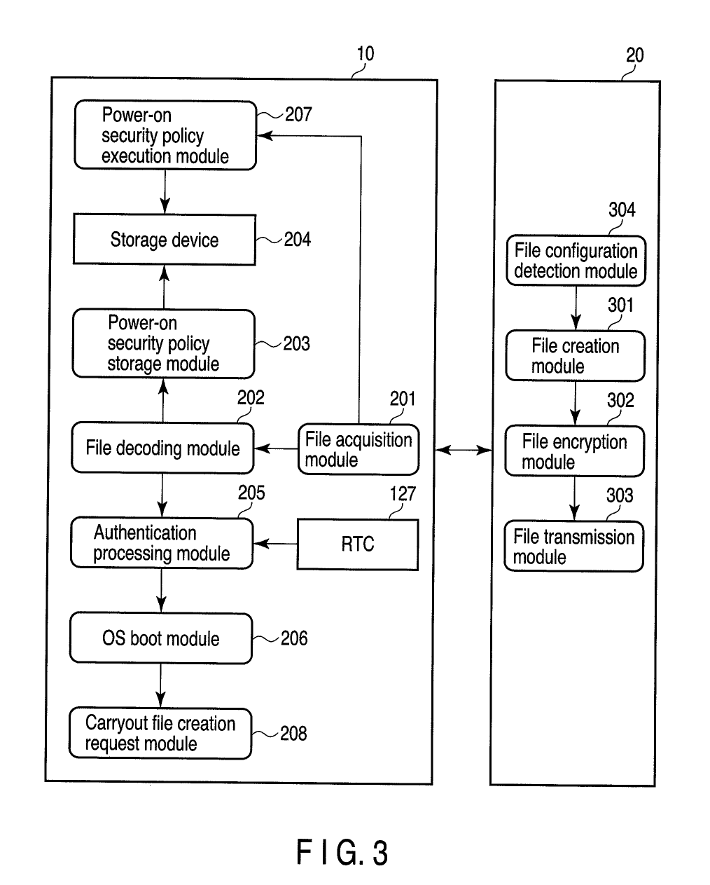

Now, a configuration for realizing the above described function will be explained. FIG. 3 shows a configuration of the computer 10 and the server 20 according to one embodiment of the present invention.

The computer 10 includes a file acquisition module 201, a file decoding module 202, a power-on security policy storage module 203, a storage device 204, an authentication processing module 205, an operating system (OS) boot module 206, a power-on security policy execution module 207, and a carryout file creation request module 208. The file acquisition module 201, the file decoding module 202, the power-on security policy storage module 203, the authentication processing module 205, the operating system (OS) boot module 206, the power-on security policy execution module 207, and the carryout file creation request module 208 are part of functions executed by the system BIOS, and are software executed by the CPU 111.

Furthermore, the server 20 includes a file creation module 301, a file encryption module 302, a file transmission module 303, and a file configuration detection module 304, etc. The file creation module 301, the file encryption module 302, the file transmission module 303, and the file configuration detection module 304 are software executed by a processor of the server 20.

The file creation module 301 creates a response file requested by the computer. The response file stores an identifier for indicating whether or not the operating system of the computer 10 can be booted, information indicating a creation time and date of the response file, and information indicating a power-on security policy for a case where the computer 10 cannot get a new response file.

The file encryption module 302 encrypts, with a public key, the response file created by the file creation module 301. The file transmission module 303 transmits the encrypted response file to the computer 10.

The file acquisition module 201 requires the server 20 to create a response file. The file acquisition module 201 then gets the encrypted response file transmitted from the file transmission module 201 of the server 20. The file acquisition module 201 transmits the got encrypted response file to the file decoding module 202 and the authentication processing module 205.

The file decoding module 202 decodes the encrypted response file with a private key, which is preliminarily provided by the server. The decoded response file is then provided to the power-on security policy storage module 203. The power-on security policy storage module 203 extracts information related to the power-on security policy out of the response file, and stores the extracted information in the storage device 204. The storage device 204 is a nonvolatile memory or a CMOS memory provided in the BIOS-ROM 120.

The authentication processing module 205 refers to the identifier included in the response file, and determines whether or not the operating system can be booted. The authentication processing module 205 compares, when it determines that the OS can be booted, the creation time and date of the response file and a present time got from the RTC for calculating a time difference. When the time difference is within a predetermined period, the authentication processing module 205 instructs the operating system boot module 206 to boot the operating system. The operating system boot module 206 boots the operating system in response to the instruction.

When the file acquisition module 201 cannot get a response file from the server 20, the file acquisition module 201 calls up the power-on security policy execution module 207. The power-on security policy execution module 207 executes a predetermined process in accordance with contents of information which relates to a power-on security policy stored in the storage device. The information related to the power-on security policy describes requirements such as not allowing boot of the operation system, a time limit until which the boot of the operating system is allowed, and execution of what is called a BIOS password authentication process.

The carryout file creation request module 208 requests, in response to a user's operation, the server 20 for creating a response file which is to be carried out. This request is transmitted when, for example, the user carries the computer 10 out of his/her office.

When an administrator of the server 20 confirms the request transmitted by the carryout file creation request module 208, the administrator inputs a configuration of the power-on security policy. The file configuration detection module 304 detects the configuration input by the administrator, and instructs the file creation module 301 to create a response file on the basis of the detected configuration.

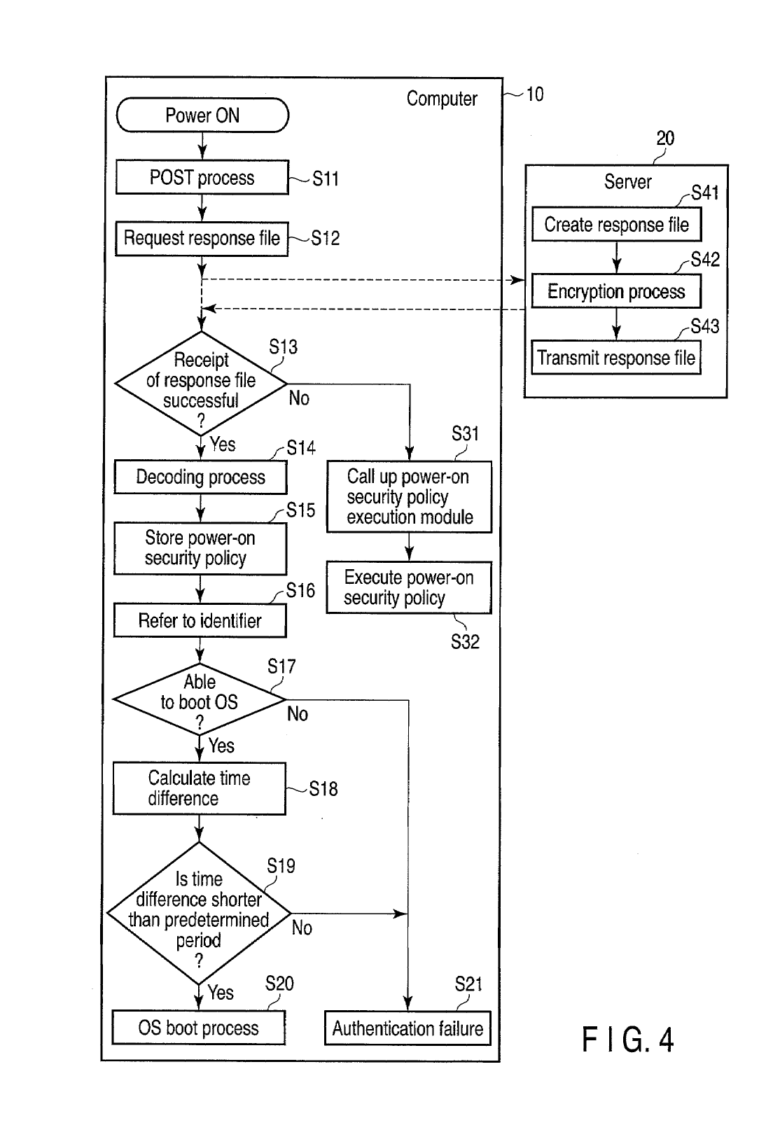

Next, processing during the system boot will be explained with reference to FIG. 4.

First of all, the system BIOS executes POST processing. In the POST processing, confirmation of devices necessary for the system boot, and initialization are executed. After the POST processing, the file acquisition module 201 requests the server 20 for a response file by using Trivial File Transfer Protocol (tftp) service (step S11).

When the computer 10 and the server 20 are connected to a network and the server 20 receives a request, the file creation module 301 creates a response file in accordance with the request (step S41). The file creation module 301 then provides the file encryption module 302 with the created response file (step S42). The file encryption module 302 encrypts the provided response file with a public key. The encrypted response file is then provided to the file transmission module 303. The file transmission module 303 transmits the encrypted response file to the computer 10 via tftp service (step S43).

After the transmission of the request, whether or not the response file has been got is determined (step S13). The computer 10 is not able to get the response file when the computer 10 and the server 20 are not connected to a network. Also, the computer 10 is not able to get the response file when the server 20 is down, even if the computer 10 and the server 20 are connected to the computer.

When the computer 10 has got a response file in response to the request (YES in step S15), the file acquisition module 201 gives the got encrypted response file to the file decoding module 202. The file decoding module 202 decodes the given encrypted response file with a private key (step S14). The file decoding module 202 then gives the decoded response file to the power-on security policy storage module 203.

The power-on security policy storage module 203 extracts information related to the power-on security policy out of the response file, and stores the extracted information in the storage device 204 (step S15).

Furthermore, the decoded response file is given to the authentication processing module 205. The authentication processing module 205 refers to the identifier in the response file (step S16), and determines whether or not the operating system can be booted (step S17). When it is determined that the operating system cannot be booted (NO in step S17), the authentication processing module 205 determines that the authentication process failed (step S21) and terminates the OS boot process.

When it is determined that the operating system can be booted (YES in step S17), the authentication processing module 205 refers to information on the creation time and date of the response file, and gets a present clock time from the RTC 127. The authentication processing module 205 then calculates a time difference between the creation time and date of the response file and the got present clock time (step S18). The authentication processing module 205 subsequently determines whether or not the calculated time difference is shorter than a predetermined period (e.g., 30 seconds) (step S19). When it is determined that the time difference is longer than the predetermined period (NO in step S19), the authentication processing module 205 determines that the authentication process failed since there is a possibility that the response file is forged (step S21), and terminates the OS boot process.

When it is determined that the time difference is shorter than the predetermined period (YES in step S19), the authentication processing module 205 determines that the authentication process has succeeded, and calls up the operating system boot module 206. The operating system boot module 206 executes a process of booting the operating system (step S20).

In a case where a response file cannot be got in response to the request in step S11 (NO in step S13), the file acquisition module 201 calls up the power-on security policy execution module 207 (step S31). The power-on security policy execution module 207 then reads out information on the power-on security policy stored in the storage device 204 and executes process in accordance with the information (step S32).

With the above process, power-on of an illegally got computer is prevented. The above process is therefore advantageous in preventing theft.

All of the processes for determining whether or not boot of the operating system can be executed by the computer 10 according to the present embodiment are realized by a computer program. Therefore, similar results can be easily realized simply by installing the computer program into conventional computers via computer-readable storage media. Furthermore, this computer program can be executed not only on computers, but also on various electronic devices incorporating processors.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing device comprising:
an information acquisition module configured to receive authentication information and power-on security policy information from a server connected to a network during power-on;
a storage module configured to store the power-on security policy information in a storage device;
an authentication module configured to authenticate of booting with the authentication information;
a boot module configured to boot an operating system when the authentication is successful; and
a power-on security policy execution module configured to execute a process based on a power-on security policy stored in the storage device, when the authentication information and the power-on security policy information are not available.

2. The information processing device of claim 1, wherein
the authentication information comprises boot availability information indicative of whether the operating system can be booted and date and time information indicative of a date and time of a creation of a file, and
the authentication module is configured to determine that the authentication is successful, when the boot availability information indicates that the operating system can be booted and a time difference between a date and time indicated by the date and time information and a time of the authentication is within a predetermined period.

3. The information processing device of claim 1, wherein
the authentication information and the power-on security policy information are encrypted, and
the information processing device further comprises a decrypting module configured to decrypt the encrypted information.

4. The information processing device of claim 1, wherein
the power-on security policy comprises at least one of first information indicative of prohibition of booting, and second information indicative of a expiry date and time for permitted booting.

5. An information processing system comprising:
a server comprising a power-on security policy creation module configured to create authentication information and power-on security policy information; and
an information processing device comprising an information acquisition module configured to receive authentication information and power-on security policy information from a server connected to a network during power-on, a storage module configured to store the power-on security information policy in a storage device, an authentication module configured to authenticate of booting with the authentication information, a boot module configured to boot an operating system when the authentication is successful, and a power-on security policy execution module configured to execute a process based on a power-on security policy stored in the storage device, when the authentication information and the power-on security policy information are not available.

6. The information processing system of claim 5, wherein
the authentication information comprises boot availability information indicative of whether the operating system can be booted and date and time information indicative of a date and time of creation of a file, and
the authentication module is configured to determine that the authentication is successful, when the boot availability information indicates that the operating system can be booted and a time difference between a date and time indicated by the date and time information and a time of the authentication is within a predetermined period.

7. The information processing system of claim 5, wherein
the server further comprises an encryption module configured to encrypt the authentication information and the power-on security policy information, and
the information processing device further comprises a decrypting module for decrypting the encrypted information.

8. The information processing system of claim 5, wherein the power-on security policy comprises at least one of first information indicative of prohibition of booting, and second information indicative of a time limit until which the boot is allowed.

9. A program stored in a computer readable media and causes a computer to determine whether an operation system can be booted, comprising:
causing the computer to obtain authentication information and power-on security policy information from a server connected to a network during power-on;
causing the computer to store the power-on security policy information in a storage device;
causing the computer to authenticate of booting with the authentication information;
causing the computer to boot the operating system, when the authentication is successful; and
causing the computer to perform a process based on a power-on security policy stored in the storage device, when the authentication information and the power-on security policy information are not available.
